(19) United States
(12) Patent Application Publication
(10) Pub. No.: US 2025/0251009 A1
(43) Pub. Date: Aug. 7, 2025

(54) Mounting Bracket and Related Methods

(71) Applicant: House of Atlas, LLC, Evanston, IL (US)

(72) Inventor: Jason Moss, Libertyville, IL (US)

(21) Appl. No.: 18/431,751

(22) Filed: Feb. 2, 2024

(51) Int. Cl. F16B 13/10; F16B 3/06; F16B 21/09

(52) U.S. Cl. CPC F16B 13/10; F16B 3/06; F16B 21/09; F16B 2200/403

(57) ABSTRACT

In one aspect, a support bracket is disclosed that includes a mounting bracket, a prong mount, and an accessory. The mounting bracket has a body to support the accessory. The prong mount has a prong and a connector. The prong is to extend through a wall to engage a backside of the wall to secure the prong mount to the wall. The connector is securable to the mounting bracket to couple the prong mount to the mounting bracket. The accessory has an attachment base configured to receive at least a portion of the body of the mounting bracket to mount the accessory to the mounting bracket.

### FIELD

This disclosure relates to mounting brackets and, in particular, to mounting brackets for wall mounted hardware.

### BACKGROUND

Many homes include wall mounted hardware, for example, curtain rod systems. Many curtain rod systems include brackets that are fastened to the wall with nails or screws. A rod holder can be attached to a bracket to support a curtain rod. Such curtain rod systems require tools for the installation of the curtain rod system which can make installation more difficult for homeowners and other non-professional installers. Such curtain rod systems may also be limited by the amount of weight they are able to support before the bracket begins pulling away from the wall, which can cause damage to the wall. Such existing curtain rod systems may limit the types of drapery material that can be used in the interior design, for example, how heavy the drapes may be. Such curtain rod systems are also prone to cause damage to the wall when, for example, a downward force is applied to the drapes (e.g., when a child pulls on the drapes).

### BRIEF DESCRIPTION OF THE DRAWINGS

FIG. 1 is a perspective view of a support bracket shown in a disassembled configuration and having a mounting bracket, a prong mount, and a rod support.

FIG. 2 is a front elevation view of the support bracket of FIG. 1 in the disassembled configuration.

FIG. 3 is a rear elevation view of the support bracket of FIG. 1 in the disassembled configuration.

FIG. 4 is a left side elevation view of the support bracket of FIG. 1 in the disassembled configuration.

FIG. 5 is a right side elevation view of the support bracket of FIG. 1 in the disassembled configuration.

FIG. 6 shows the prong mount of FIG. 1 detached from the mounting bracket of FIG. 1.

FIG. 7 is a front perspective view of the prong mount of FIG. 1 attached to the mounting bracket of FIG. 1.

FIG. 8 is a rear perspective view of the prong mount of FIG. 1 attached to the mounting bracket of FIG. 1.

FIG. 9A is a perspective view of the support bracket of FIG. 1 in an assembled configuration.

FIG. 9B is a left perspective view of the support bracket of FIG. 1 in the assembled configuration.

FIG. 10 is a rear perspective view of the support bracket of FIG. 1 in an assembled configuration.

FIG. 11 is a left side elevation view of the support bracket of FIG. 1 in the assembled configuration, showing the support bracket mounted to a wall.

FIG. 12 is a top perspective view of a rear portion of the support bracket of FIG. 1.

FIG. 13 is a perspective view of a support bracket according to another embodiment shown in a disassembled configuration and having the mounting bracket, the prong mount, and a rod support according to another embodiment.

FIG. 14 is a bottom view of the support bracket of FIG. 13 in an assembled configuration.

FIG. 15 is a front perspective view of the support bracket of FIG. 13 in an assembled configuration.

FIG. 16 is a rear perspective view of the support bracket of FIG. 13 in the assembled configuration.

FIG. 17 is a front perspective view of a support bracket according to another embodiment shown in a disassembled configuration and having the mounting bracket, the prong mount, and a rod support according to another embodiment.

FIG. 18 is a bottom perspective view of the support bracket of FIG. 17 in the disassembled configuration.

FIG. 19 is a front perspective view of the support bracket of FIG. 17 in an assembled configuration.

FIG. 20 is a rear perspective view of the support bracket of FIG. 17 in the assembled configuration.

### DETAILED DESCRIPTION

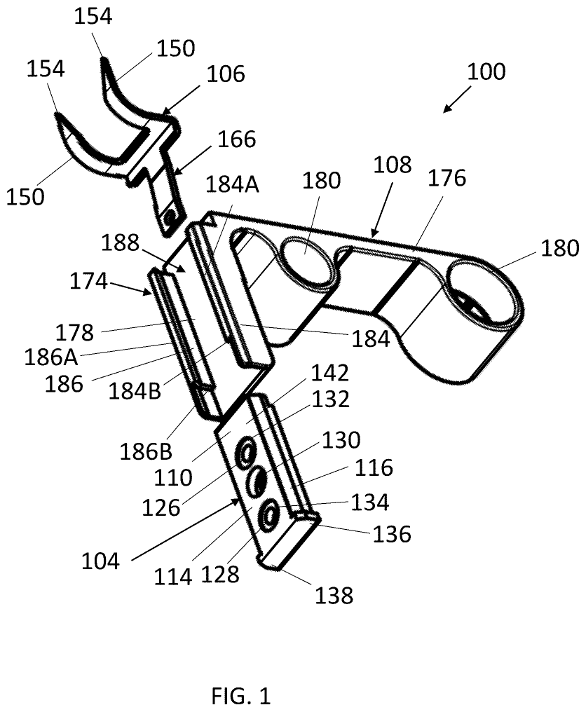

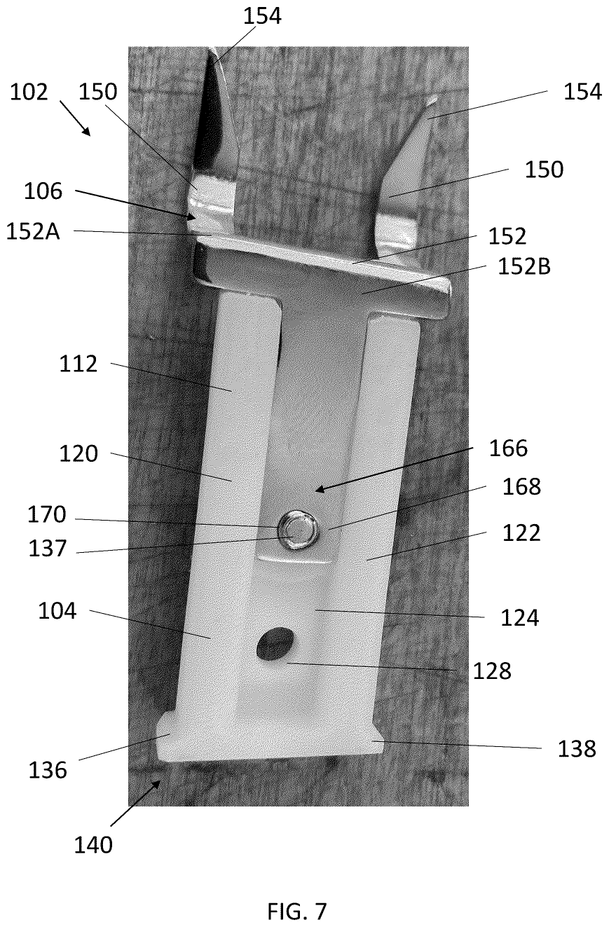

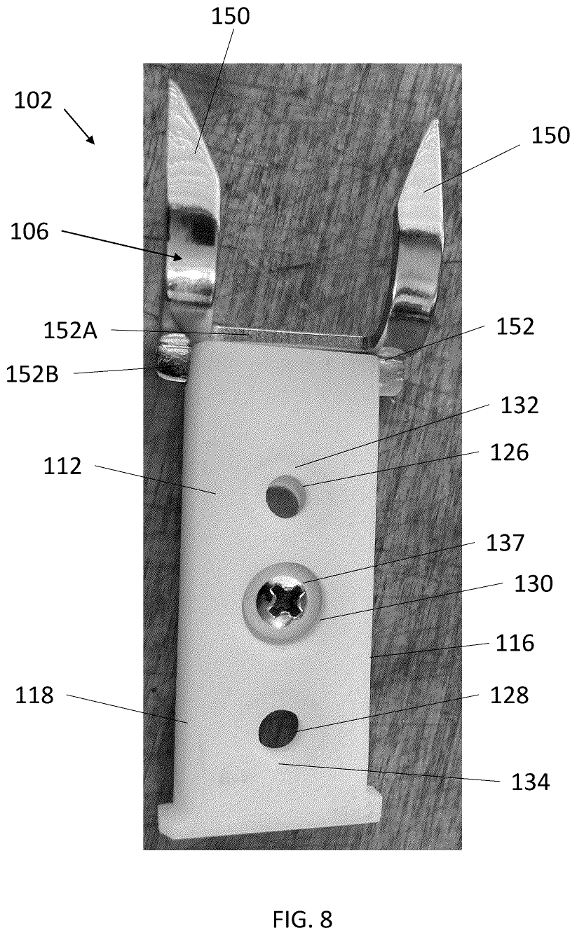

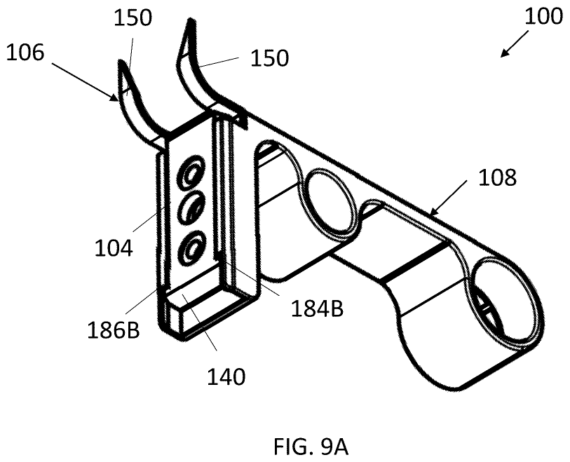

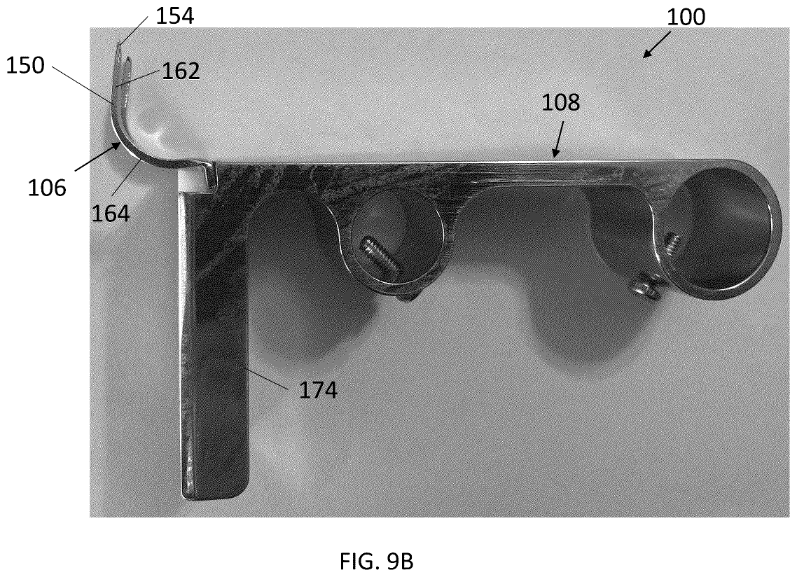

With respect to FIGS. 1-12, a support bracket 100 is provided for attachment to a mounting surface, such as a wall, to support an accessory, such as a curtain rod. The support bracket 100 is shown in a disassembled configuration in FIGS. 1-5 and in an assembled configuration in FIGS. 9-12. The support bracket 100 has an attachment bracket 102 (see FIGS. 7-8) to be secured to the wall and an accessory, such as a rod support 108, that may be mounted on the attachment bracket 102 to secure the rod support 108 to the wall. While the following discussion primarily refers to the rod support 108 as the accessory mounted to the attachment bracket 102, other accessories may similarly be mounted to the attachment bracket 102 such as a shelf, coat rack, toilet paper holder, etc.

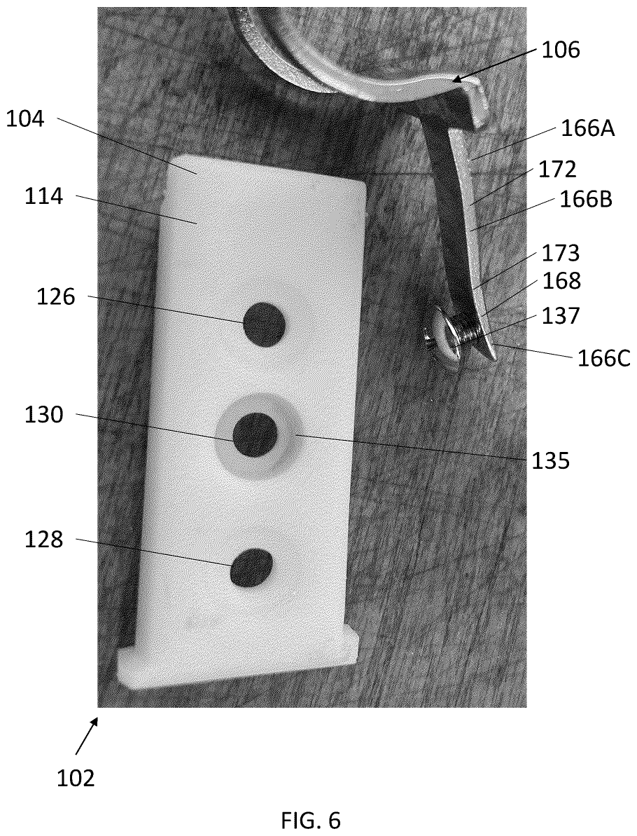

With reference also to FIGS. 6-8, the attachment bracket 102 includes a mounting bracket 104 and a prong mount 106. The mounting bracket 104 includes a body 110 with a front surface 112 and a rear surface 114. The body 110 includes side edges 116, 118 that extend from the front surface 112 to the rear surface 114 and along a length of the body 110. At least a portion of the side edges 116, 118 are tapered inward as they extend from the front surface 112 to the rear surface 114 (see also FIG. 3). The tapered side edges 116, 118 form an inner rail to permit an accessory (e.g., the rod support 108) to be slid over the mounting bracket 104 to attach the accessory to a mounting surface as described in further detail below.

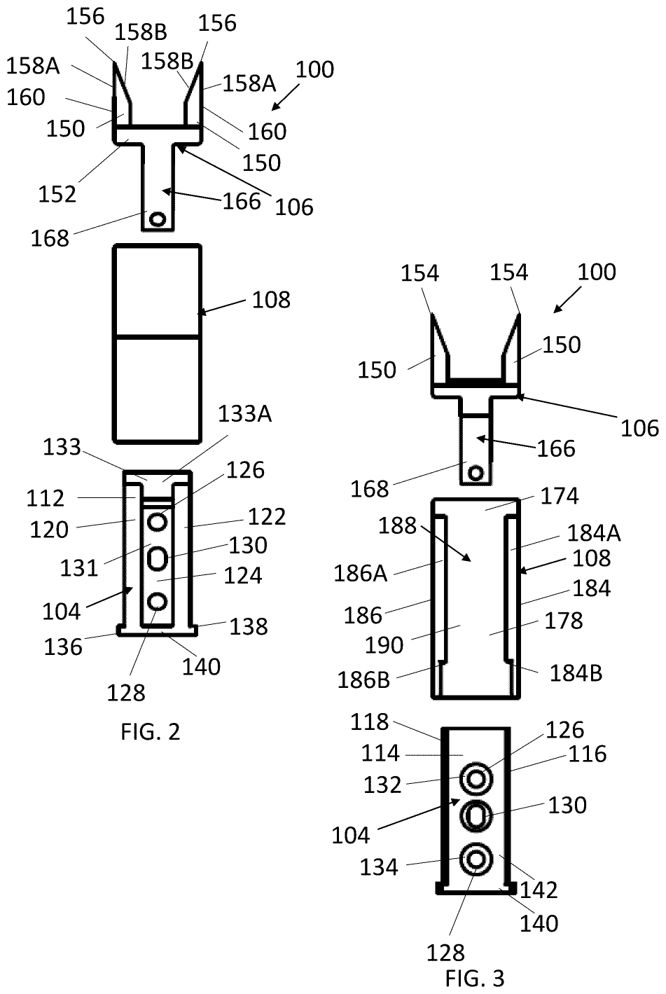

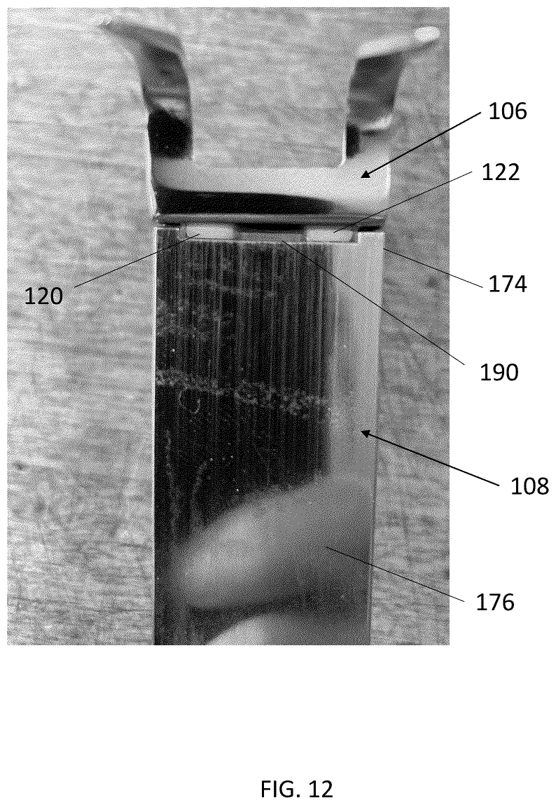

The front side of the body 110 of the mounting bracket 104 has support portions 120, 122 spaced apart to form a channel 124 (see FIGS. 2 and 7). The support portions 120, 122 contact the accessory mounted on the mounting bracket 104 to maintain the accessory aligned with the body 110 and to absorb load applied to the accessory. For example, when the rod support 108 is attached to the mounting bracket 104, an inner surface 190 (see FIG. 12) of a base 174 of the rod support 108 contacts or rests against the support portions 120, 122, which transfers the load to the wall 146 and counters the load on a support arm 176 of the rod support 108. Countering the load on the support arm 176 reduces the force with which the base 174 of the rod support 108 pulls on the upper portion of the mounting bracket 104.

The channel 124 includes mounting openings 126, 128. In one mounting approach, fasteners (e.g., screws, nails) may be extended through the mounting openings 126, 128 from the front side of the body 110 and into a wall which the rear surface 114 of the mounting bracket 104 is in contact with. Positioning the mounting openings 126, 128 in the channel 124 of the body 110 provides clearance for heads of the fasteners such that the fasteners do not extend beyond the front surface 112 of the support portions 120, 122. This ensures the support portions 120, 122 contact the accessory when the accessory is mounted on the attachment bracket 102 as discussed above.

The rear side of the body 110 includes the rear surface 114 having the mounting openings 126, 128 and the attachment opening 130. The rear surface 114 of the body 110 may have countersinks 132, 134 (see FIGS. 3 and 8) about the mounting openings 126, 128. The countersinks 132, 134 provide space to receive a portion of a wall anchor extending from the wall (e.g., a flange of the wall anchor) such that the rear surface 114 of the body 110 lays flat against the mounting surface. Fasteners may be extended through the mounting openings 126, 128 and into wall anchors in the wall to mount the attachment bracket 102 to the wall.

The channel 124 further includes an attachment opening 130. In another mounting approach, the attachment opening 130 is used to secure an attachment tab 166 of the prong mount 106 to the mounting bracket 104 as discussed below. The channel 124 may have a raised portion 131 (see FIG. 2) that extends about the attachment opening 130. The raised portion 131 provides a surface for the attachment tab 166 to contact that extends parallel to the front surface 133A (see FIG. 2) of an upper portion 133 of the mounting bracket 104.

The rear surface 114 of the body 110 may include a countersink 135 about the attachment opening 130 (see FIG. 6). The countersink 135 provides space to receive a head of a fastener 137 extended through the attachment opening 130. The fastener 137 may be extended through the mounting bracket 104 from the rear side to the front side of the body 110 to secure the attachment tab 166 of the prong mount 106 to the mounting bracket 104. The raised portion 131 of the mounting bracket 14 may increase the thickness of the mounting bracket 104 at the attachment opening 130, which may, for example, at least partially offset the reduced thickness from the countersink 135.

The body 110 of the mounting bracket 104 includes a base 140 with support flanges 136, 138 (see FIGS. 1-2) that extend outward from the sides of the body 110. The base 140 of the mounting bracket 104 that has a greater width than an upper portion 142 of the mounting bracket 104 extending upward from the base 140 (see FIG. 3). The support flanges 136, 138 of the base 140 form a stop or support ledge that an accessory attached to the mounting bracket 104 contacts to support the accessory attached thereto.

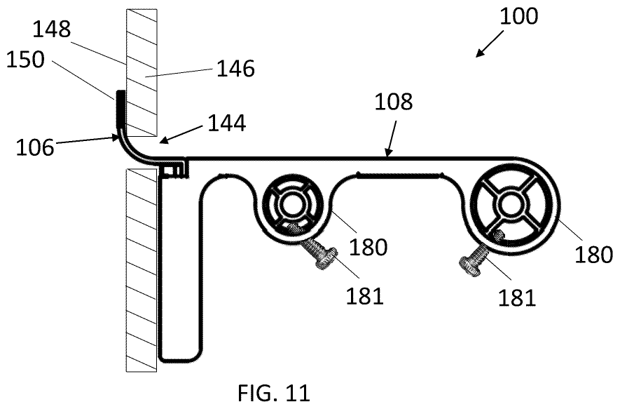

The prong mount 106 may be used to form holes 144 (see FIG. 11) in a wall 146. Alternatively, the holes 144 may be formed with another tool, e.g., a drill. Once holes 144 have been formed, the prong mount 106 is inserted part way through the holes 144 to engage a backside 148 of the wall 146 (see FIG. 11).

With reference to FIGS. 1-2 and 7-8, the prong mount 106 includes a generally U-shaped portion defined by two prongs 150 extending from a central portion 152. The central portion 152 has an L-shaped cross-section formed by a first leg 152A and a second leg 152B that extend at an angle relative to one another (e.g., a 90-degree angle). The first leg 152A connects to the prongs 150 and the second leg 152B connects to the attachment tab 166. The central portion 152 may seat on the upper portion 133 of the mounting bracket 104. For example, the first leg 152A of the central portion 152 may rest on a top of the upper portion 133 (see FIG. 8) while the second leg 152B extends along a front side of the upper portion 133 (see FIG. 7). The second leg 152B may be supported by ends of the support portions 120, 122 as shown in FIG. 7. The interconnection of the prong mount 106 with the mounting bracket 104 supports the prong mount 106 in alignment with the mounting bracket 104, for example, by inhibiting the prong mount 106 from pivoting substantially relative to the mounting bracket 104. The first leg 152A may also secure the rod support 108 to the mounting bracket 104 by limiting travel of the rod support 108 along the mounting bracket 104 when the support bracket 100 is assembled, as discussed below.

Each prong 150 includes a pointed tip 154. Each pointed tip 154 includes an apex 156 and two lateral edges 158A and 158B (see FIGS. 1-2) on opposite sides of the apex 156 that extend downwardly from the apex 156. The lateral edge 158A is an extension of an outer edge 160 of the prong 150, and the lateral edge 158B angles towards the lateral edge 158A to the apex 156. The lateral edges 158A, 158B are not symmetrical in that they form an asymmetrical tip 154. In other forms, the pointed tips 154 may be symmetrical, with the lateral edges 158A, 158B angling at the same rate to the apex 156.

The pointed tips 154 of the prongs 150 may be used to puncture the wall 146 to form the holes 144. When the support bracket 100 is installed, the prongs 150 extend through the holes 144 in the wall with the pointed tips 154 contacting the backside 148 of the wall 146. With the prongs 150 in contact with the backside 148 of the wall 146, the prong mount 106 inhibits the support bracket 100 from pivoting in the holes 144. The width of the prong mount 106 may also be greater than the height of the holes 144, which also limits the prong mount 106, and thus the support bracket 100, from pivoting in the holes 144. For example, the holes 144 may each have a height and width that is substantially the same as the cross-section of the prong 150. The prongs 150 may be used to penetrate the wall 146 to form the holes 144 without the use of tools.

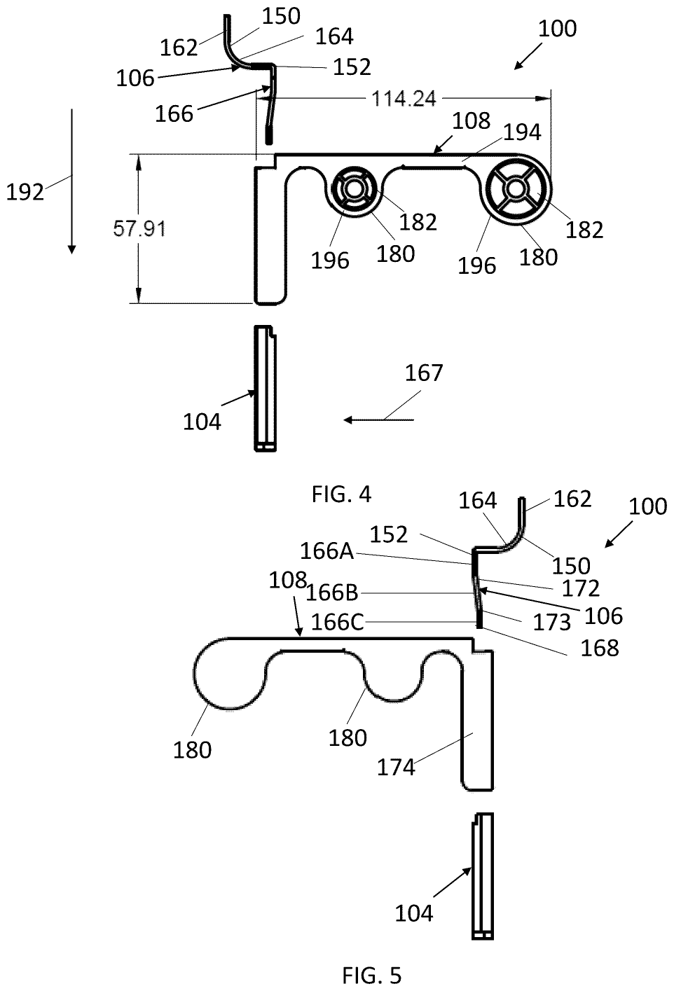

With reference to FIGS. 4 and 9B, each prong 150 includes a straight section 162 and a curved section 164. The straight section 162 is behind the wall 146 when the prong mount 106 is installed on the wall 146 (see FIG. 11) and supports the pointed tip 154 in engagement with the wall. The curved section 164 may engage the top of the hole 144 near or at the backside 148 of the wall 146 (see FIG. 11) to limit movement of the prong mount 106 in the hole 144. The curved section 164 extends from the central portion 152 of the prong mount 106. With respect to FIG. 9B, the curved section 164 may curve more than 90-degrees such that the straight section 162 extends at an angle toward the wall 146 from the curved section 164 to support the point tip 154 into engagement with the wall 146.

With reference to FIGS. 2 and 7, the prong mount 106 includes a connector such as the attachment tab 166 to secure the prong mount 106 to the mounting bracket 104. The tab 166 extends from the central portion 152 at an angle relative to the prongs 150 (e.g., approximately a 90-degree angle) to extend along the front side of the body 110 of the mounting bracket 104. The tab 166 has a width that is narrower than the channel 124 of the body 110 of the mounting bracket 104 such that the tab 166 extends within the channel 124 between the two support portions 120, 122. The support portions 120, 122 may limit lateral movement of the tab 166 in the channel 124 which keeps the prong mount 106 in alignment with the mounting bracket 104. The tab 166 has a connecting portion 168 to connect the prong mount 106 to the mounting bracket 104. The connecting portion 168 includes a threaded opening 170 that may be aligned with the attachment opening 130 to secure the prong mount 106 to the mounting bracket 104. The fastener 137 may be extended through the attachment opening 130 and threaded to the threaded opening 170 of the prong mount 106 to secure the prong mount 106 to the mounting bracket 104.

With the tab 166 extending in the channel 124 between the support portions 120, 122 and the central portion 152 of the prong mount 106 seated on the upper portion 133 of the mounting bracket 104, the prong mount 106 is fixed from moving substantially relative to the mounting bracket 104. The tab 166 may thus be used to rigidly couple the prong mount 106 to the mounting bracket 104. With the prong mount 106 rigidly coupled to the mounting bracket 104, the prong mount 106 aids to resist force that pulls the upper portion of the mounting bracket 104 away from the wall. As force is applied to the attachment bracket 102 to pull the upper portion of the mounting bracket 104 from the wall (e.g., weight on the rod support 108), the prongs 150 engage the backside 148 of the wall 146 to resist movement of the mounting bracket 104 from the wall 146.

With reference to FIGS. 5-6, the tab 166 of the prong mount 106 may include an inner segment 166A, a middle segment 166B, and an outer segment 166C separated by bends 172, 173, respectively. The inner segment 166A may extend generally parallel to the outer segment 166C. The outer segment 166C includes the connecting portion 168 to secure the prong mount 106 to the mounting bracket 104. The middle segment 166B may extend obliquely relative to the inner segment 166A and outer segment 166C to support the outer segment 166C rearward and in a different plane from the inner segment 166A. The inner segment 166A may contact a front surface of the upper portion 133 (see FIG. 2) of the mounting bracket 104, and the outer segment 166C may contact a front surface of the raised portion 131 in the channel 124 of the mounting bracket 104 (see FIG. 2). The segments and bends of the tab 166 permit the tab 166 to rest securely against the corresponding surfaces of the mounting bracket 104. As shown in FIG. 6, the attachment tab 166 may taper to a lesser thickness at a terminal end of the outer portion.

With respect to FIGS. 1, 4, and 5, the rod support 108 includes a base 174 and a support arm 176 extending from the base 174. The base 174 of the rod support 108 may be slid onto the attachment bracket 102 to removably mount the rod support 108 to the attachment bracket 102. The base 174 has an attachment leg 178 that extends at least substantially perpendicularly to a support arm 176 supporting rod receptacles 180. The rod receptacles 180 include a recess 182 (e.g., a cylindrical recess) sized to receive an end of a rod (e.g., a curtain rod or towel rod). In the embodiment shown, there are two rod receptacles 180 such that the rod support 108 may be used to support two rods, for example, a rod for a sheer and a rod for drapes. In the embodiment shown, the rod receptacles 180 are unitarily formed (as a single piece) with the support arm 176. The support arm 176 includes an arm portion 194 and protruding portions 196 (see FIG. 4) that extend generally below the arm portion 194. The rod receptacles 180 are formed in the protruding portions 196. With reference to FIG. 11, the rod receptacles 180 may include threaded openings in a sidewall thereof into which fasteners 181 may be extended to secure a rod in the rod receptacles 180.

The support bracket 100 may be part of a rod support system that includes one or more other similar support brackets 100 for supporting a rod. For example, another attachment bracket 102 may be used to mount a similar rod support 108 to receive the opposite end of the rods. The two rod supports 108 together support the rod therebetween. The rod support system may also include one or more rod supports 108 mounted along the length of the rod to support middle portions of the rod. The middle rod supports 108 may have rod receptacles with openings (e.g., cylindrical openings), rather than recesses, that the rods extend through.

The base 174 of the rod support 108 includes sidewalls 184, 186 (see FIGS. 1 and 3) that extend from the attachment leg 178 away from the support arm 176. The sidewalls 184, 186 each include end portions or opposing protrusions 184A, 186A that angle or toe inward to hook the tapered side edges 116, 118 of the upper portion 142 of the mounting bracket 104. The sidewalls 184, 186 thus form an elongated slot 188 to receive at least the upper portion 142 of the mounting bracket 104. The base 174 of the rod support 108 thus is able to slide along the length of the mounting bracket 104 with the opposing protrusions 184A, 186A hooking the upper portion 142 of the mounting bracket 104 to inhibit substantial lateral movement therebetween. Further, the opposing protrusions 184A, 186A and the tapered side edges 116, 118, respectively, may complement one another such that there is at least substantially no lateral play between the base 174 and the mounting bracket 104. The lower ends 184B, 186B of the opposing protrusions 184A, 186A may contact the support flanges 136, 138 of the mounting bracket 104, which serves to limit the amount the base 174 of the rod support 108 is able to slide over the mounting bracket 104.

With reference to FIG. 12, the attachment leg 178 contacts the support portions 120, 122 of the body 110 of the mounting bracket 104. The support portions 120, 122 engage the inner surface 190 of the attachment leg 178 to inhibit the rod support 108 from pivoting relative to the mounting bracket 104. For example, a load on support arm 176 of the rod support 108 may apply a force to the attachment leg 178 urging the attachment leg 178 to pull away from the mounting bracket 104. The engagement between the attachment leg 178 and support portions 120, 122 counters this force. The size of the surface of the support portions 120, 122 is preferably large enough relative to the overall size of the mounting bracket 104 to absorb the load on the support arm 176. The support portions 120, 122 also may extend along a substantial portion of the length of the attachment leg 178 to inhibit pivoting of the rod support 108 relative to the mounting bracket 104.

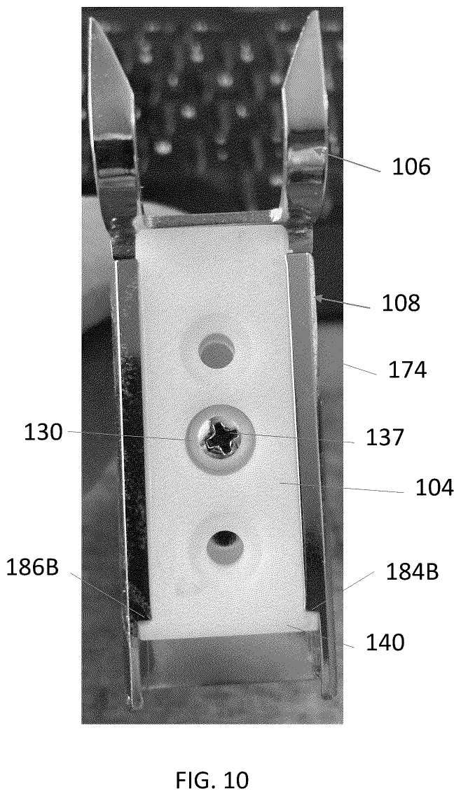

The attachment bracket 102 permits the rod support 108 to be mounted to the wall according to multiple approaches. This provides the installer with mounting options when installing the support bracket 100. In one approach, to mount the support bracket 100 to a wall, the rod support 108 is attached to the mounting bracket 104. The lower end of the base 174 of the rod support 108 may be aligned with the upper portion 142 of the mounting bracket 104 to align the elongated slot 188 of the base 174 with the body 110 of the mounting bracket 104. The rod support 108 is slid downward along the body 110 in direction 192 (see FIG. 4) with the sidewalls 184, 186 wrapping partially about the tapered side edges 116, 118 of the mounting bracket 104 until the lower ends 184B, 186B of the sidewalls 184, 186 of the rod support 108 contact the base 140 of the mounting bracket 104 (as shown in FIGS. 9-10). The sidewalls 184, 186 may extend near the rear surface 114 of the body 110 of the mounting bracket 104 so that the sidewalls 184, 186 extend near the wall and conceal the mounting bracket 104.

The tab 166 of the prong mount 106 is inserted into the channel portion 124 of the mounting bracket 104 between the mounting bracket 104 and the base 174 of the rod support 108. The tab 166 may be inserted until the central portion 152 seats on the upper portion 133 of the mounting bracket 104 and the connecting portion 168 of the tab 166 is aligned with the attachment opening 130 of the mounting bracket 104. The fastener 137 is extended through the attachment opening 130 from the rear side of the mounting bracket 104. The fastener is threaded to the threaded opening 170 of the connecting portion 168 to secure the prong mount 106 to the mounting bracket 104. The fastener 137 may be threaded until an end of the fastener 137 contacts the inner surface 190 of the base 174 of the rod support 108 to secure the rod support 108 from movement along the mounting bracket 104. The horizontal portion 152A of the central portion 152 of the prong mount 106 is positioned above the sidewalls 184, 186 of the base 174 of the rod support 108, which inhibits the rod support 108 from being removed from the mounting bracket 104.

To secure the assembled support bracket 100 to a wall, the prongs 150 of the prong mount 106 are pressed into the wall 146 at the desired mounting location. The straight sections 162 of the prongs 150 are pressed through the wall 146 forming the holes 144 therein. As the curved sections 164 of the prongs 150 are advanced into the holes 144, the prong mount 106 is pivoted to bring the pointed tips 154 into contact with the backside 148 of the wall 146 and the mounting bracket 104 toward the front side of the wall 146 as shown in FIG. 11.

In an alternative mounting approach, the prong mount 106 may not be used. The mounting bracket 104 is positioned at the desired mounting location on a wall. Fasteners are extended through the mounting openings 126, 128 of the mounting bracket 104 in direction 167 (see FIG. 4) and into the wall 146 to secure the mounting bracket 104 on the wall. In some approaches, wall anchors may first be inserted into the wall, and then, the fasteners are inserted through the mounting openings 126, 128 and into the wall anchors. The rod support 108 may then be slid on to the mounting bracket 104 as described above.

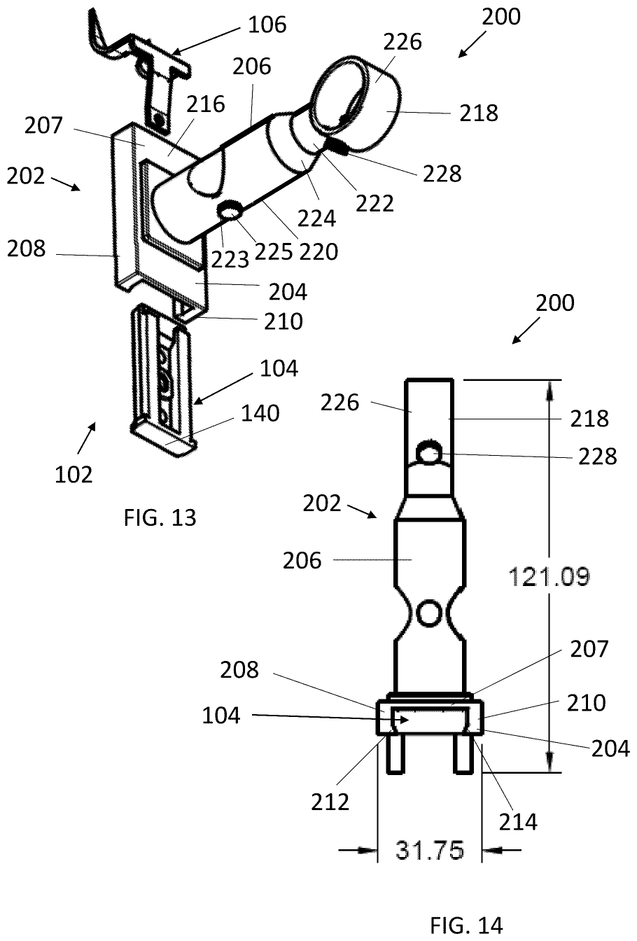

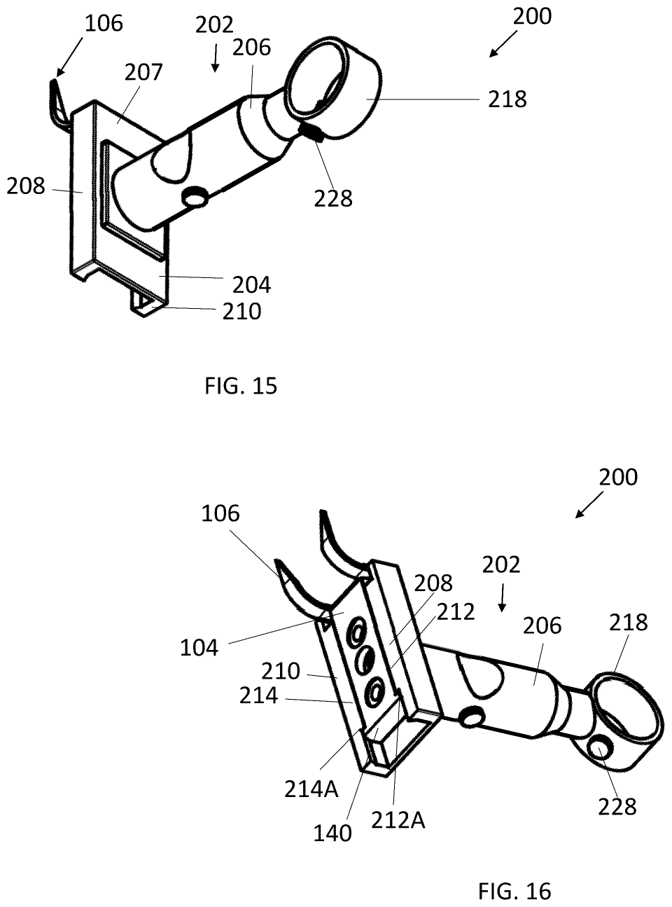

With reference to FIGS. 13-16, a support bracket 200 according to another embodiment is provided. The support bracket 200 is similar to the support bracket 100 of FIG. 1 discussed above such that mainly the differences will be highlighted. The support bracket 200 includes the attachment bracket 102 discussed above with a different rod support 202. The rod support 202 includes a base 204 and a support arm 206.

The base 204 of the rod support 202 is similar in many respects to the base 174 of the rod support 108 of FIG. 1. The base 204 is generally rectangular in shape and includes a base wall 207 and sidewalls 208, 210 extending rearwardly from the base wall 207. Ends of sidewalls 208, 210 opposite the base wall 207 have opposing protrusions 212, 214 that angle or toe inward to hook the tapered side edges 116, 118 of the upper portion 142 of the mounting bracket 104 as the base 204 is slid over the mounting bracket 104. Lower ends 212A, 214A of the opposing protrusions 212, 214 may contact the base 140 of the mounting bracket 104 to limit how far the base 204 of the rod support 202 is able to be slid over the mounting bracket 104.

The support arm 206 is mounted to a central portion of the base 204 and extends from a front side 216 of the base 204 to a rod holder 218. The support arm 206 is generally cylindrical having a large diameter portion 220, a small diameter portion 222, and a tapered portion 224 therebetween. The large diameter portion 220 extends from the base 204 to the tapered portion 224. The small diameter portion 222 extends from the tapered portion 224 to the rod holder 218. The support arm 206 may receive a post extending from the front side 216 of the base 204. The support arm 206 may include a threaded opening 223 into which a screw 225 may be threaded to secure the support arm 206 to the post of the base 204. In some forms, the support arm 206 is extendable. For example, the support arm 206 may be slid axially along the post of the base 204 to a desired position. The screw 225 may be tightened to secure the support arm 206 at the desired position relative to the base 204. As another example, the large diameter portion 220 of the support arm 206 telescopes with the small diameter portion 222 to adjust the length of the support arm 206. The screw 225 may be tightened to fix the large diameter portion 220 from movement relative to the small diameter portion 222.

The rod holder 218 includes a ring 226 through which a rod may be extended to support the rod. The ring 226 may include a threaded opening into which a screw 228 may be threaded to secure the rod in the ring 226 and to inhibit the rod from sliding relative to the rod support 202.

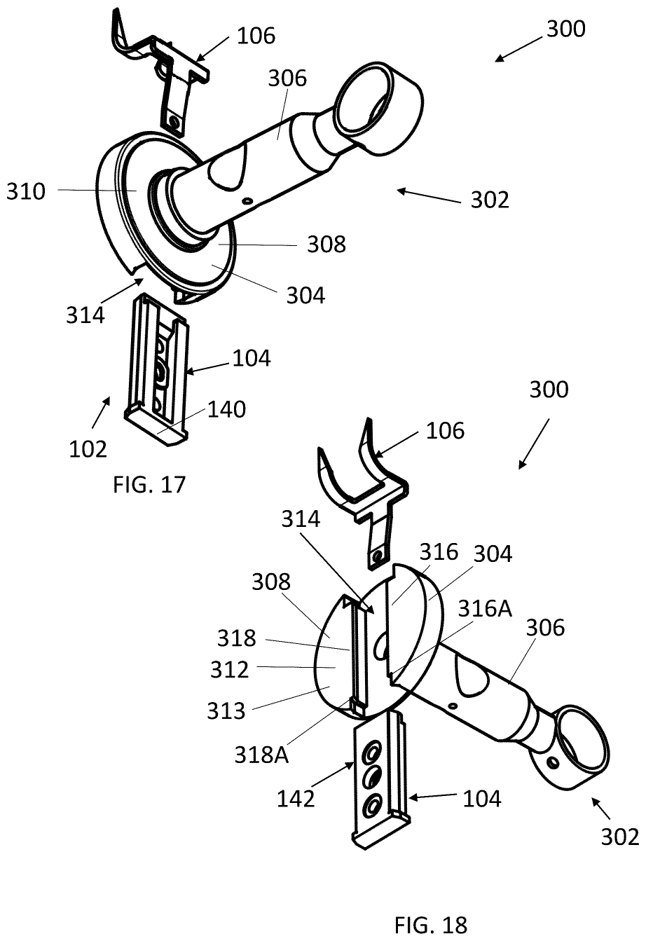

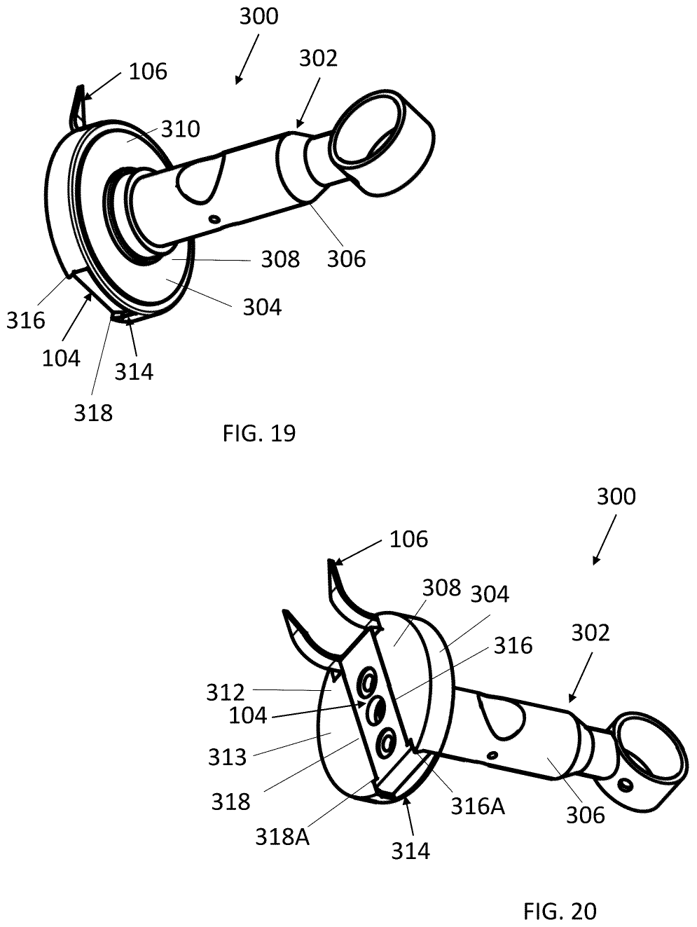

With reference to FIGS. 17-20, a support bracket 300 is provided according to another embodiment. The support bracket 300 is similar to the support bracket embodiments discussed above such that the mainly the differences will be highlighted. The support bracket 300 includes the attachment bracket 102 described above with a different rod support 302. The rod support 302 includes a base 304 and a support arm 306. The support arm 306 is like that of the support arm 206 of FIGS. 13.

The base 304 of the rod support 302 is generally disc shaped and has a body 308 with a front side 310 and a rear side 312. The rear side 312 of the body 308 has a rear surface 313 to contact the wall 146 to which the support bracket 300 is mounted. The rear side 312 of the body 308 defines a slot 314 sized to receive the upper portion 142 of the mounting bracket 104 to secure the rod support 302 to the attachment bracket 102. The body 308 includes opposing protrusions 316, 318 on opposite sides of the slot 314 that extend inwardly toward one another and extend along a portion of the length of the slot 314. To secure the rod support 302 to the attachment bracket 102, the slot 314 of the base 304 may be aligned with upper end of the mounting bracket 104 and slid over the mounting bracket 104 with the protrusions 316, 318 hooking the tapered side edges 116, 118 of the mounting bracket 104. The protrusions 316, 318 may have ends 316A, 318A that contact the base 140 of the mounting bracket 104 to limit movement of the rod support 302 as it slides relative to the mounting bracket 104. When the rod support 302 is mounted to the mounting bracket 104, the body 308 of the base 304 extends about the mounting bracket 104 to conceal the mounting bracket 104. In the embodiment shown, the body 308 of the base 304 is a circular plate, however, the base may have other shapes and designs to provide the desired aesthetic appearance.

While the support bracket embodiments described above include a rod support for supporting a rod (e.g., a curtain rod) that is mounted on the attachment bracket 102, the support bracket may include an accessory of a different configuration to support other items on a wall, for example, a shelf, coat rack, toilet paper holder, etc. For instance, a rear portion of the accessory may include a base that slidably receives the upper portion of the mounting bracket 104 while the front portion of the accessory is configured to support other types of wall mounted items.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. An attachment bracket comprising:
a mounting bracket slidingly engaging an accessory to attach the accessory to the mounting bracket; and
a mount having at least one prong and a connector, the at least one prong having a pointed tip to be extended through a wall to engage a backside of the wall, the connector securable to the mounting bracket to couple the prong mount to the mounting bracket such that the at least one prong resists movement of the mounting bracket from the wall.

2. The attachment bracket of claim 1 wherein the mounting bracket defines a channel sized to receive the connector of the mount.

3. The attachment bracket of claim 2 wherein the channel defines an opening to secure the connector of the mount to the mounting bracket.

4. The attachment bracket of claim 3 comprising a fastener sized to extend into the opening and thread into a threaded opening defined by the connector of the mount to secure the mount to the mounting bracket.

5. The attachment bracket of claim 4 wherein the mounting bracket includes a rear surface to engage the wall, the rear surface having a recess about the opening of the mounting bracket to receive a head of the fastener.

6. The attachment bracket of claim 1 wherein the mount includes a central portion between the at least one prong and the connector, the central portion profiled to seat on a portion of the mounting bracket.

7. The attachment bracket of claim 1 wherein the mounting bracket includes tapered side edges to slidingly engage the accessory.

8. The attachment bracket of claim 1 wherein the mounting bracket includes a base to support the accessory.

9. The attachment bracket of claim 1 wherein the at least one prong is disposed at an angle to the connector.

10. The attachment bracket of claim 1 wherein the at least one prong includes two prongs spaced apart from one another.

11. The attachment bracket of claim 1 wherein the mounting bracket defines at least one mounting opening to receive a fastener to secure the mounting bracket to the wall.

12. A support bracket comprising:
a mounting bracket having a body;
a mount having at least one prong and a connector, the at least one prong to extend through a wall to engage a backside of the wall to secure the prong mount to the wall, the connector securable to the mounting bracket to couple the mount to the mounting bracket; and
an accessory having an attachment base configured to receive at least a portion of the mounting bracket to attach the accessory to the mounting bracket.

13. The support bracket of claim 12 wherein the attachment base of the accessory includes a slot to slidably receive the body of the mounting bracket.

14. The support bracket of claim 12 wherein the attachment base includes opposing protrusions to hook a portion of the body of the mounting bracket.

15. The support bracket of claim 12 wherein the accessory is a rod support having a support arm extending from the attachment base to a rod holder.

16. The support bracket of claim 12 wherein the body of the mounting bracket includes a support base, the attachment base of the accessory to contact the support base to support the accessory.

17. The support bracket of claim 12 wherein the prong mount is securable to the mounting bracket to limit movement of the accessory along the body of the mounting bracket.

18. The support bracket of claim 12 wherein the body of the mounting bracket has tapered side edges to engage the accessory to mount the accessory to the wall.

19. The support bracket of claim 12 wherein the connector of the prong mount includes an attachment tab having an attachment opening to secure the prong mount to the body of the mounting bracket.

20. The support bracket of claim 12 wherein the body includes support portions profiled to engage the accessory and a recessed portion between the support portions to receive the connector of the prong mount.

21. The support bracket of claim 20 wherein the recessed portion further includes an attachment opening to secure the connector of the prong mount to the body of the mounting bracket.

22. A method of mounting a support bracket comprising:
sliding an attachment base of an accessory over a mounting bracket to insert a portion of a body of the mounting bracket into an attachment slot of the attachment base;
securing an attachment tab of a prong mount to the mounting bracket; and
inserting a prong of the prong mount through a wall to bring the prong into contact with a backside of the wall.

23. The method of claim 22 wherein securing the attachment tab to the mounting bracket includes inserting a fastener through the mounting bracket and into a threaded opening of the attachment tab.

24. The method of claim 22 further comprising inserting the attachment tab of the prong mount into a recessed portion of the mounting bracket until the prong mount seats on the mounting bracket.
